(19) United States
(12) Patent Application Publication
(10) Pub. No.: US 2026/0107322 A1
(43) Pub. Date: Apr. 16, 2026

(54) AMBIENT DEVICE RANDOM ACCESS MESSAGE TRANSMISSIONS

(71) Applicant: QUALCOMM Incorporated, San Diego, CA (US)

(72) Inventors: Raviteja PATCHAVA, San Diego, CA (US); Piyush GUPTA, Bridgewater, NJ (US); Yuchul KIM, San Diego, CA (US); Kazuki TAKEDA, Minato-ku (JP); Le LIU, San Jose, CA (US)

(21) Appl. No.: 19/319,580

(22) Filed: Sep. 4, 2025

Related U.S. Application Data
(60) Provisional application No. 63/705,738, filed on Oct. 10, 2024.

(51) Int. Cl. H04W 74/0833

(52) U.S. Cl. CPC H04W 74/0833

(57) ABSTRACT

Various aspects of the present disclosure generally relate to wireless communication. Some aspects more specifically relate to ambient device random access message transmissions. A network node may transmit, and an ambient device may receive, configuration information that indicates a minimum permitted duration and a maximum permitted duration for transmitting a random access message. A reader device may transmit a query message to the ambient device. The ambient device may transmit, and the reader device may receive, a random access message that includes a pseudorandom noise sequence and a redundancy sequence. The redundancy sequence may include a portion of the pseudorandom noise sequence. A duration of the redundancy sequence may be in accordance with the minimum permitted duration and the maximum permitted duration. For example, the duration of the redundancy sequence may be equal to the maximum permitted duration subtracted by the minimum permitted duration.

### CROSS-REFERENCE TO RELATED APPLICATION

This patent application claims priority to U.S. Provisional Patent Application No. 63/705,738, filed on Oct. 10, 2024, entitled “AMBIENT DEVICE RANDOM ACCESS MESSAGE TRANSMISSIONS,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with ambient device random access message transmissions.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

An ambient device is an Internet of Things (IoT) device that is designed to operate with limited memory and battery resources. The ambient device may be equipped with sensors and/or other hardware that enable the ambient device to collect data. Additionally, the ambient device may be configured with hardware and/or software that enable the ambient device to transmit and receive data over a wireless communication network. Ambient IoT technology may be useful in connection with industrial sensors, for which battery replacement may be prohibitively difficult or undesirable (such as for safety monitoring or fault detection in smart factories, infrastructures, or environments). Additionally, features of ambient devices, such as low cost, small size, simple or infrequent maintenance, durability, and long lifespan may facilitate smart logistics and warehousing (for example, in connection with automated asset management).

### SUMMARY

Some aspects described herein relate to a method for wireless communication by an ambient device. The method may include receiving, from a reader device, a query message. The method may include transmitting, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message.

Some aspects described herein relate to a method for wireless communication by a reader device. The method may include transmitting, to an ambient device, a query message. The method may include receiving, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message.

Some aspects described herein relate to an ambient device for wireless communication. The ambient device may include a processing system that includes one or more processors and one or more memories coupled with the one or more processors. The processing system may be configured to cause the ambient device to receive, from a reader device, a query message. The processing system may be configured to cause the ambient device to transmit, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message.

Some aspects described herein relate to a reader device for wireless communication. The reader device may include a processing system that includes one or more processors and one or more memories coupled with the one or more processors. The processing system may be configured to cause the reader device to transmit, to an ambient device, a query message. The processing system may be configured to cause the reader device to receive, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message.

Some aspects described herein relate to a non-transitory computer-readable medium that stores a set of instructions for wireless communication by an ambient device. The set of instructions, when executed by one or more processors of the ambient device, may cause the ambient device to receive, from a reader device, a query message. The set of instructions, when executed by one or more processors of the ambient device, may cause the ambient device to transmit, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message.

Some aspects described herein relate to a non-transitory computer-readable medium that stores a set of instructions for wireless communication by a reader device. The set of instructions, when executed by one or more processors of the reader device, may cause the reader device to transmit, to an ambient device, a query message. The set of instructions, when executed by one or more processors of the reader device, may cause the reader device to receive, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message.

Some aspects described herein relate to an apparatus for wireless communication. The apparatus may include means for receiving, from a reader device, a query message. The apparatus may include means for transmitting, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message.

Some aspects described herein relate to an apparatus for wireless communication. The apparatus may include means for transmitting, to an ambient device, a query message. The apparatus may include means for receiving, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example of random access messages with pseudorandom noise sequences in accordance with the present disclosure.

FIG. 4 is a diagram illustrating an example of ambient device random access transmissions in accordance with the present disclosure.

FIG. 5 is a diagram illustrating an example of random access messages with pseudorandom noise sequences and redundancy sequences in accordance with the present disclosure.

FIG. 6 is a flowchart illustrating an example process performed, for example, at an ambient device or an apparatus of an ambient device that supports wireless communications in accordance with the present disclosure.

FIG. 7 is a flowchart illustrating an example process performed, for example, at a reader device or an apparatus of a reader device that supports wireless communications in accordance with the present disclosure.

FIG. 8 is a diagram of an example apparatus for wireless communication that supports wireless communications in accordance with the present disclosure.

FIG. 9 is a diagram of an example apparatus for wireless communication that supports wireless communications in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

An ambient device is an Internet of Things (IoT) device that is designed to operate with limited memory and battery resources. The ambient device may be equipped with sensors and/or other hardware that enable the ambient device to collect data. Additionally, the ambient device may be configured with software and/or hardware that enable the ambient device to transmit and receive data over a wireless communication network. Ambient IoT technology may be useful in connection with industrial sensors, for which battery replacement may be prohibitively difficult or undesirable (such as for safety monitoring or fault detection in smart factories, infrastructures, or environments). Additionally, features of ambient devices, such as low cost, small size, simple or infrequent maintenance, durability, and long lifespan may facilitate smart logistics and warehousing (for example, in connection with automated asset management). Furthermore, ambient IoT technology may be useful in connection with smart home networks for household item management, wearable devices, or similar applications.

Ambient devices may communicate with a reader device. For example, the reader device may communicate with multiple ambient devices to collect data obtained by one or more sensors of the multiple ambient devices. In some cases, the reader device may detect one or more ambient devices within an environment using an inventory process. The inventory process may include the reader device transmitting a query message (Message 0) within the environment. One or more ambient devices that receive the query message may transmit random access messages (Message 1) to the reader device. For example, ambient devices having one or more characteristics indicated in the query message may transmit random access messages back to the reader device. The inventory process may further include the reader device transmitting a resource allocation message (Message 2) to the ambient device (or multiple ambient devices) responsive to the reader device receiving the random access messages from the ambient device. The resource allocation message may allocate one or more resources to be used by the ambient device for transmitting information (such as an electronic product code (EPC) identifier (ID) of the ambient device) back to the reader device. The ambient device may transmit the information (Message 3) to the reader device responsive to the ambient device receiving the resource allocation message. The inventory process may even further include the reader device transmitting an acknowledgement message to the ambient device responsive to the reader device receiving the information (such as the EPC ID) from the ambient device.

A network node may allocate multiple time-division multiplexing (TDM) resources and/or frequency-division multiplexing (FDM) resources to be used by the ambient device for transmitting the random access message. The ambient device, responsive to receiving the query message from the reader device, may transmit the random access message (Message 1) to the reader device using the allocated TDM or FDM resources and/or using one or more code-division multiplexing (CDM) resources. In some examples, the ambient device may be configured to begin transmitting the random access message to the reader device within a duration of the ambient device receiving the query message. The duration may be defined by a minimum permitted duration between the ambient device receiving the query message and the ambient device transmitting the random access message and by a maximum permitted duration between the ambient device receiving the query message and the ambient device transmitting the random access message. The ambient device may transmit the random access message at a random time within this duration, for example, in accordance with a processing delay of the ambient device, a round-trip time for communications between the ambient device and the reader device, or a sampling frequency offset (SFO) used by the ambient device.

In some cases, multiple ambient devices may transmit random access messages to the same reader device within the same duration in accordance with different processing delays, different round-trip times, or different sampling frequency offsets. For example, a first ambient device may transmit a random access message to the reader device at a time that corresponds to the minimum permitted duration and a second ambient device may transmit a random access message to the reader device at a time that corresponds to the maximum permitted duration. This may result in a loss of orthogonality of the random access messages at the reader device. This loss of orthogonality of the random access messages at the reader device may result in decreased detection performance by the reader device. Additionally, transmitting random access messages at different times within the duration may result in increased power consumption at the ambient devices. For example, guard bands may be used to offset the timing differences between the random access message transmissions, which may result in increased transmission durations by the ambient devices and increased periods of wake times by the ambient devices. Further, transmitting random access messages at different times within the duration may result in increased network resource consumption. For example, longer guard times may result in an increased quantity of network resources being used for communicating the random access messages.

Various aspects generally relate to wireless communications. Some aspects more specifically relate to ambient device random access message transmissions. A network node may transmit, and an ambient device may receive, configuration information that includes an indication of a minimum permitted duration and a maximum permitted duration for the ambient device. The minimum permitted duration and the maximum permitted duration may be in accordance with at least one of a processing delay of the ambient device, a round-trip time for communications between the ambient device and the reader device, or a sampling frequency offset used by the ambient device. A reader device may transmit a query message to the ambient device. In accordance with receiving the query message, the ambient device may transmit, and the reader device may receive, a random access message that includes a pseudorandom noise (PN) sequence and a redundancy sequence (RS). The redundancy sequence may include a portion of the pseudorandom noise sequence. For example, the redundancy sequence may include a repetition of a portion of the pseudorandom noise sequence. A duration of the redundancy sequence may be in accordance with the minimum permitted duration and the maximum permitted duration. For example, the duration of the redundancy sequence may be equal to the maximum permitted duration subtracted by the minimum permitted duration. In some examples, the random access message includes the pseudorandom noise sequence followed by the redundancy sequence. In these examples, the redundancy sequence includes a repetition of an initial portion of the pseudorandom noise sequence, where the initial portion of the pseudorandom noise sequence has a duration of the maximum permitted duration subtracted by the minimum permitted duration. In some other examples, the random access message includes the redundancy sequence followed by the pseudorandom noise sequence. In these examples, the redundancy sequence includes a repetition of an end portion of the pseudorandom noise sequence, where the end portion of the pseudorandom noise sequence has a duration of the maximum permitted duration subtracted by the minimum permitted duration.

In some aspects, the reader device may receive multiple random access messages from multiple ambient devices. For example, the reader device may receive a first random access message from a first ambient device and may receive a second random access message from a second ambient device. The first random access message may include a first pseudorandom noise sequence that begins at a time that corresponds to the minimum permitted duration, or at a time that is after the minimum permitted duration but before a beginning of the second random access message, and may include a first redundancy sequence that follows the first pseudorandom noise sequence. The second random access message may include a second pseudorandom noise sequence that begins at a time that corresponds to the maximum permitted duration, or at a time that is before the maximum permitted duration but after a beginning of the first random access message, and may include a second redundancy sequence that follows the second pseudorandom noise sequence. The first redundancy sequence may be a repetition of a portion of the first pseudorandom noise sequence having a duration of the maximum permitted duration subtracted by the minimum permitted duration. The first pseudorandom noise sequence and the second pseudorandom noise sequence may not be aligned in the time domain (for example, may not be orthogonal). However, an end of the first redundancy sequence, which includes the repetition of the portion of the first pseudorandom noise sequence, may align with an end of the second pseudorandom noise sequence. This may enable the reader device to begin reading or processing the first pseudorandom noise sequence and the second pseudorandom noise sequence at a time that corresponds to the maximum permitted duration, and to complete reading or processing the first pseudorandom noise sequence and the pseudorandom noise sequence at a time that corresponds to the end of the first redundancy sequence and the end of the second pseudorandom noise sequence.

Particular aspects of the subject matter described in this disclosure can be implemented to realize one or more of the following potential advantages. In some examples, by enabling communications of random access messages that include pseudorandom noise sequences and redundancy sequences, the described techniques can be used to improve orthogonality of random access messages. For example, by enabling communications of a first random access message and a second random access message, where an end of a redundancy sequence of the first random access message aligns with an end of a pseudorandom noise sequence of the second random access message, the described techniques can be used to enable the reader device to process the first random access message and the second random access message as orthogonal messages. In some examples, by enabling communications of random access messages that include pseudorandom noise sequences and redundancy sequences, the described techniques can be used to increase detection performance by the reader device. In some examples, by enabling communications of random access messages that include pseudorandom noise sequences and redundancy sequences, the described techniques can be used to decrease power consumption by the ambient devices. For example, by enabling communications of the first random access message and the second random access message, where the end of the redundancy sequence of the first random access message aligns with the end of the pseudorandom noise sequence of the second random access message, the described techniques can be used to reduce or eliminate guard times, thereby decreasing transmission times by the ambient devices and decreasing wake times by the ambient devices. In some examples, by enabling communications of random access messages that include pseudorandom noise sequences and redundancy sequences, the described techniques can be used to decrease network resource consumption. For example, by enabling communications of the first random access message and the second random access message, where the end of the redundancy sequence of the first random access message aligns with the end of the pseudorandom noise sequence of the second random access message, the described techniques can be used to reduce or eliminate guard times, which may reduce a quantity of resources used for communicating the random access messages. These example advantages, among others, are described in more detail below.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (cMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

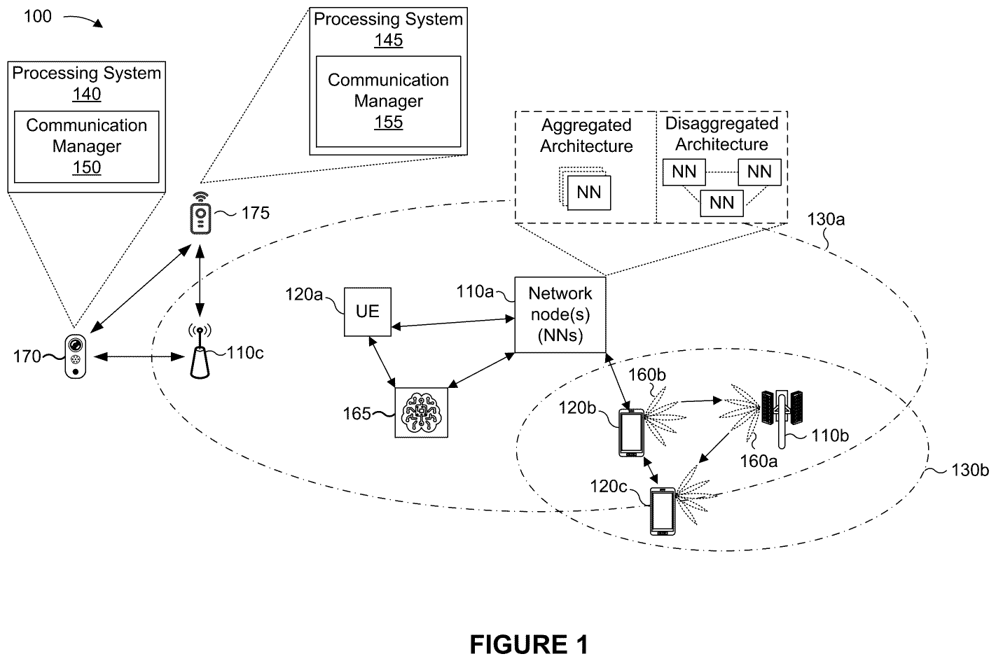

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple user equipment (UEs) 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110. In some examples, a network node 110 (such as the network node 110c) may communicate with an ambient device 170. Additionally or alternatively, a reader device 175 may communicate with the ambient device 170. In some examples, the reader device 175 may be the network node 110c. In some other examples, the reader device 175 may be a UE that operates between the reader device 175 and the network node 110c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, in accordance with user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

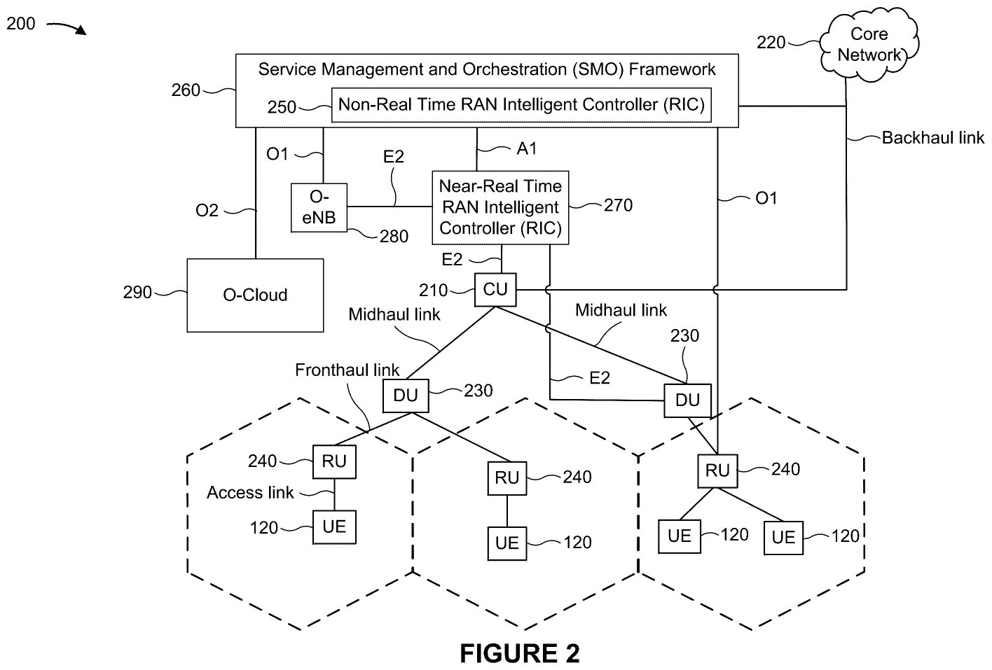

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

An ambient device is an IoT device that is designed to operate with limited memory and battery resources. The ambient device 170 may be equipped with sensors and/or other hardware that enable the ambient device 170 to collect data. Additionally, the ambient device 170 may be configured with hardware and/or software that enable the ambient device 170 to transmit and receive data over a wireless communication network. Ambient IoT technology may include passive IoT (such as NR passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive IoT device referred to as an “ambient backscatter device” or a “backscatter device,” which may modulate a reflecting radio signal from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. Ambient IoT technology may be useful in connection with industrial sensors, for which battery replacement may be prohibitively difficult or undesirable (such as for safety monitoring or fault detection in smart factories, infrastructures, or environments). Additionally, features of ambient IoT devices, such as low cost, small size, simple or infrequent maintenance, durability, and long lifespan, may facilitate smart logistics and warehousing (for example, in connection with automated asset management). Furthermore, ambient IoT technology may be useful in connection with smart home networks for household item management, wearable devices, or similar applications.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mm Wave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the ambient device 170 may include a communication manager 150. As described in more detail elsewhere herein, the communication manager 150 may receive, from a reader device, a query message; and transmit, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message. Additionally or alternatively, the communication manager 150 may perform one or more other operations described herein.

In some aspects, the reader device 175 may include a communication manager 155. As described in more detail elsewhere herein, the communication manager 155 may transmit, to an ambient device, a query message; and receive, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message. Additionally or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

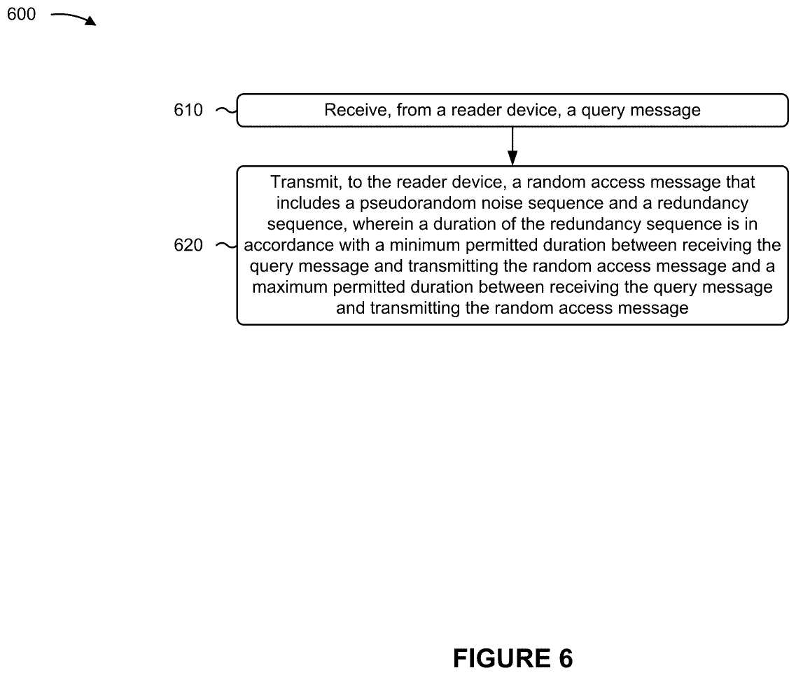

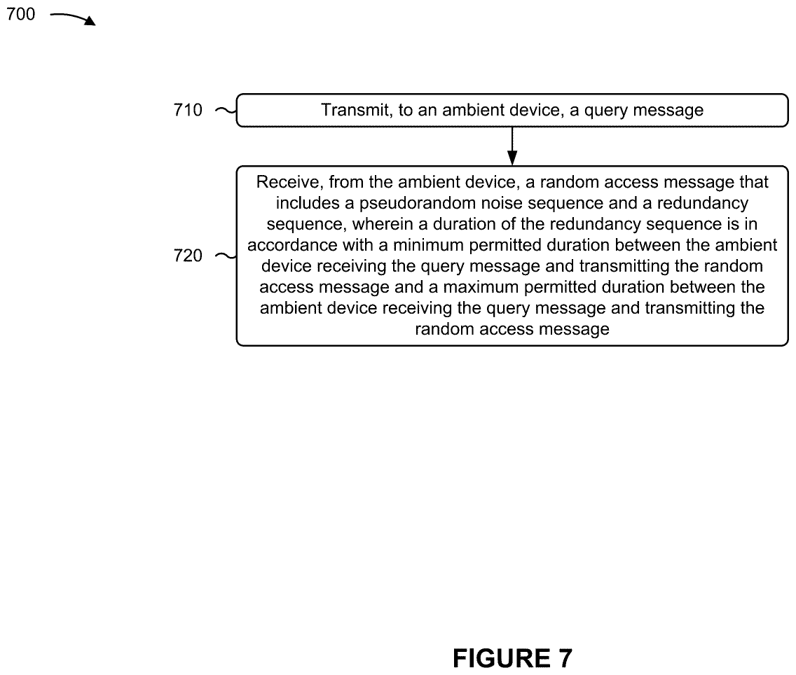

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with ambient device random access message communications, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

In some aspects, the ambient device 170 includes means for receiving, from a reader device, a query message; and/or means for transmitting, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message. In some aspects, the means for the ambient device 170 to perform operations described herein may include, for example, one or more of communication manager 150, processing system 145, a radio, one or more RF chains, one or more transceivers, one or more antennas, one or more modems, a reception component, and/or a transmission component, among other examples. In some aspects, the means for the ambient device 170 to perform operations described herein may include, for example, one or more of communication manager 150, processing system 140, a radio, one or more RF chains, one or more transceivers, one or more antennas, one or more modems, a reception component, and/or a transmission component, among other examples.

In some aspects, the reader device 175 includes means for transmitting, to an ambient device, a query message; and/or means for receiving, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message. In some aspects, the means for the reader device 175 to perform operations described herein may include, for example, one or more of communication manager 155, processing system 145, a radio, one or more RF chains, one or more transceivers, one or more antennas, one or more modems, a reception component, and/or a transmission component, among other examples. In some aspects, the means for the reader device to perform operations described herein may include, for example, one or more of communication manager 155, processing system 140, a radio, one or more RF chains, one or more transceivers, one or more antennas, one or more modems, a reception component, and/or a transmission component, among other examples.

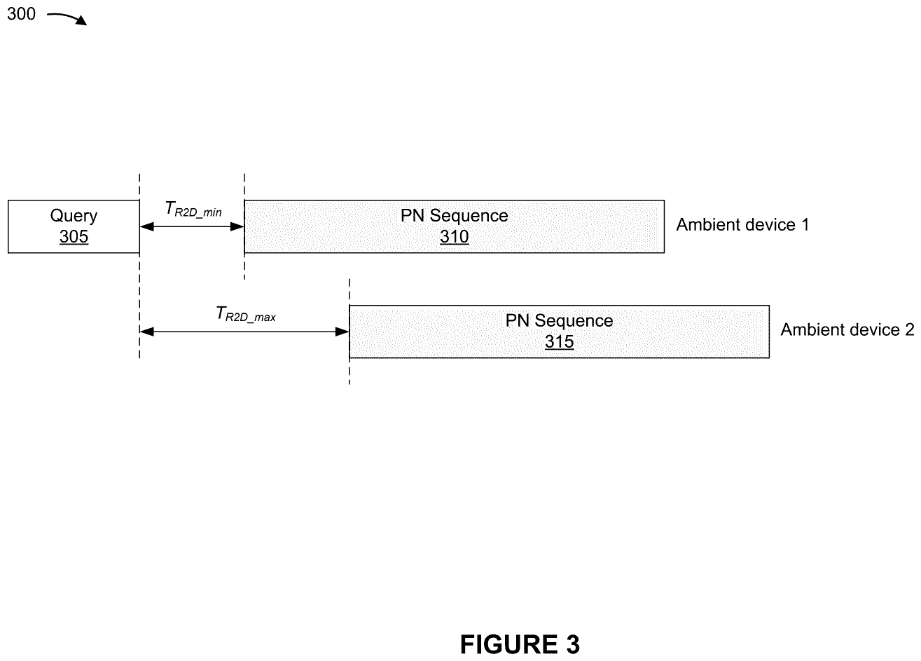

FIG. 3 is a diagram illustrating an example 300 of random access messages with pseudorandom noise sequences in accordance with the present disclosure.

A network node may allocate resources to be used by an ambient device. For example, the network node 110 may allocate resources to be used by the ambient device 170 (or multiple ambient devices 170) for communicating with the reader device 175. In some cases, the resource allocation may indicate multiple TDM resources and/or FDM resources to be used by the ambient device 170 for transmitting random access messages. The ambient device 170, responsive to receiving a query message from the reader device 175, may transmit a random access message to the reader device 175 using the allocated TDM or FDM resources and/or using one or more CDM resources. In some cases, FDM can be achieved by using different frequency shifts for backscattering by the ambient device 170. Additionally or alternatively, ambient devices 170 may use binary orthogonal sequences for transmitting random access messages using CDM, for example, since the ambient devices 170 may not support complex waveforms such as physical random access channel (PRACH) waveforms. In these cases, the ambient devices 170 may transmit data to the reader device 175 using pseudorandom noise sequences.

As shown in the example 300, ambient devices 170 may transmit random access messages to the reader device 175 within a duration of the ambient devices 170 receiving a query 305. As described herein, the query 305 may be a Message 1 of an inventory process by the reader device 175. The duration may be defined by a minimum permitted duration (T_{R2D_min}) between the ambient device 170 receiving the query message and the ambient device 170 transmitting the random access message and by a maximum permitted duration (T_{R2D_max}) between the ambient device 170 receiving the query message and the ambient device 170 transmitting the random access message. Therefore, an ambient device 170 may be configured to transmit the random access message to the reader device 175 at a time that is greater than or equal to T_{R2D_min} after the ambient device 170 receives the query message and that is less than or equal to T_{R2D_max} after the ambient device 170 receives the query message. The ambient device 170 may transmit the random access message at a random time within this duration, for example, in accordance with a processing delay of the ambient device 170 or a sampling frequency offset used by the ambient device 170.

The reader device 175 may transmit the query 305 to one or more ambient devices 170 within an environment. Responsive to receiving the query 305, multiple ambient devices 170 may transmit random access messages to the reader device 175 in accordance with different processing delays of the ambient devices 170 or different sampling frequency offsets used by the ambient devices 170. For example, a first ambient device 170 (shown as ambient device 1) may transmit a first random access message that includes a PN sequence 310 at a time that corresponds to T_{R2D_min}. Additionally, a second ambient device 170 (shown as ambient device 2) may transmit a second random access message that includes a PN sequence 315 at a time that corresponds to T_{R2D_max}. The PN sequence 310 and the PN sequence 315 may not be orthogonal with each other. This lack of orthogonality of the random access messages may result in decreased detection performance by the reader device 175. Additionally, transmitting random access messages at different times within the duration may result in increased power consumption at the ambient devices 170. For example, guard bands may be used to offset the timing differences between the random access message transmissions, which may result in increased transmission durations by the ambient devices 170 and increased periods of wake times by the ambient devices 170. Further, transmitting random access messages at different times within the duration may result in increased network resource consumption. For example, longer guard times may result in an increased quantity of network resources being used for communicating the random access messages.

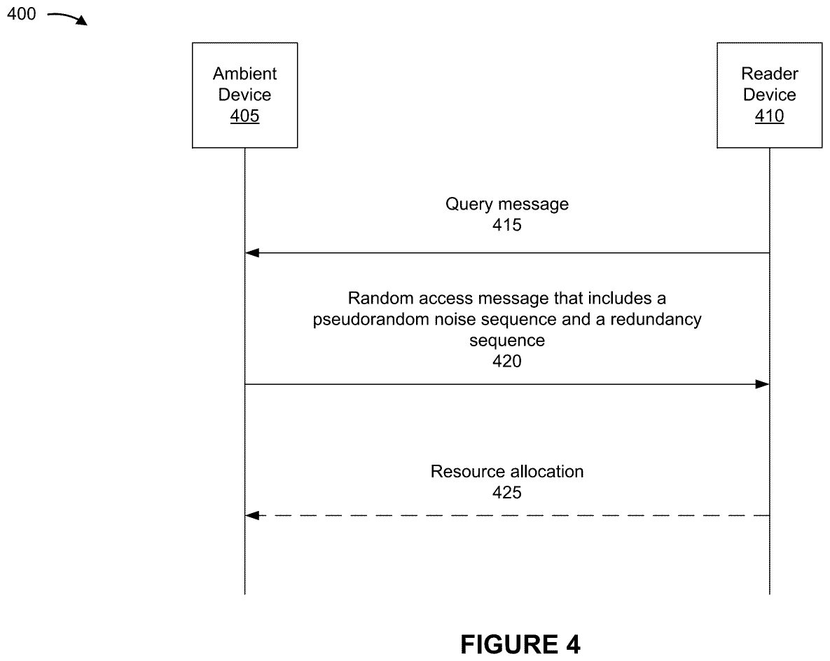

FIG. 4 is a diagram illustrating an example 400 of ambient device random access transmissions in accordance with the present disclosure. An ambient device 405 may communicate with a reader device 410. The ambient device 405 may include some or all of the features of the ambient device 170. Additionally or alternatively, the reader device 410 may include some or all of the features or components of the reader device 175. In some aspects, the reader device 410 may be a network node, such as the network node 110. In these aspects, the reader device 410 may allocate resources to be used by the ambient device 405 and may collect data obtained by one or more components (such as one or more sensors) of the ambient device 405. In some other aspects, the reader device 410 may be another device, such as the UE 120, that is located between the ambient device 405 and the network node 110. In these aspects, the network node 110 may allocate resources to be used by the ambient device 405, and the reader device 410 may collect data obtained by the one or more components of the ambient device 405.

In a first operation 415, the reader device 410 may transmit, and the ambient device 405 may receive, a query message. The query message may be associated with an inventory process by the reader device 410. For example, the query message may be a Message 0 of the inventory process. The query message may be used by the reader device 410 to discover one or more ambient devices 405 within an environment.

In a second operation 420, the ambient device 405 may transmit, and the reader device 410 may receive, a random access message that includes a pseudorandom noise sequence and a redundancy sequence. The ambient device 405 may be configured to transmit the random access message at any time within a duration (for example, at a random time within the duration). The duration may be defined by a minimum permitted duration and a maximum permitted duration. The minimum permitted duration may be an earliest time at which the ambient device 405 can begin transmitting the random access message after receiving the query message, and the maximum permitted duration may be a latest time at which the ambient device 405 is to begin transmitting the random access message after receiving the query message. The minimum permitted duration and the maximum permitted duration may be in accordance with at least one of a processing delay of the ambient device 405, a round-trip time for communications between the ambient device 405 and the reader device 410, or a sampling frequency offset used by the ambient device 405. The redundancy sequence may include a portion of the pseudorandom noise sequence and may have a duration that is in accordance with the minimum permitted duration and the maximum permitted duration. For example, the redundancy sequence may be a repetition of an initial portion (or an end portion) of the pseudorandom noise sequence and may have a duration that is equal to the maximum permitted duration subtracted by the minimum permitted duration.

In some aspects, the redundancy sequence may be included after the pseudorandom noise sequence in the random access message. In this example, the redundancy sequence may be a repetition of an initial portion of the pseudorandom noise sequence, where the initial portion of the pseudorandom noise sequence has a duration that is equal to the maximum permitted duration subtracted by the minimum permitted duration. Therefore, the initial portion of the pseudorandom noise sequence may be repeated as a postfix at the end of the pseudorandom noise sequence. In some other aspects, the redundancy sequence may be included before the pseudorandom noise sequence in the random access message. In this example, the redundancy sequence may be a repetition of an end portion of the pseudorandom noise sequence, where the end portion of the pseudorandom noise sequence has a duration that is equal to the maximum permitted duration subtracted by the minimum permitted duration. Therefore, the end portion of the pseudorandom noise sequence may be repeated as a prefix at the beginning of the pseudorandom noise sequence.

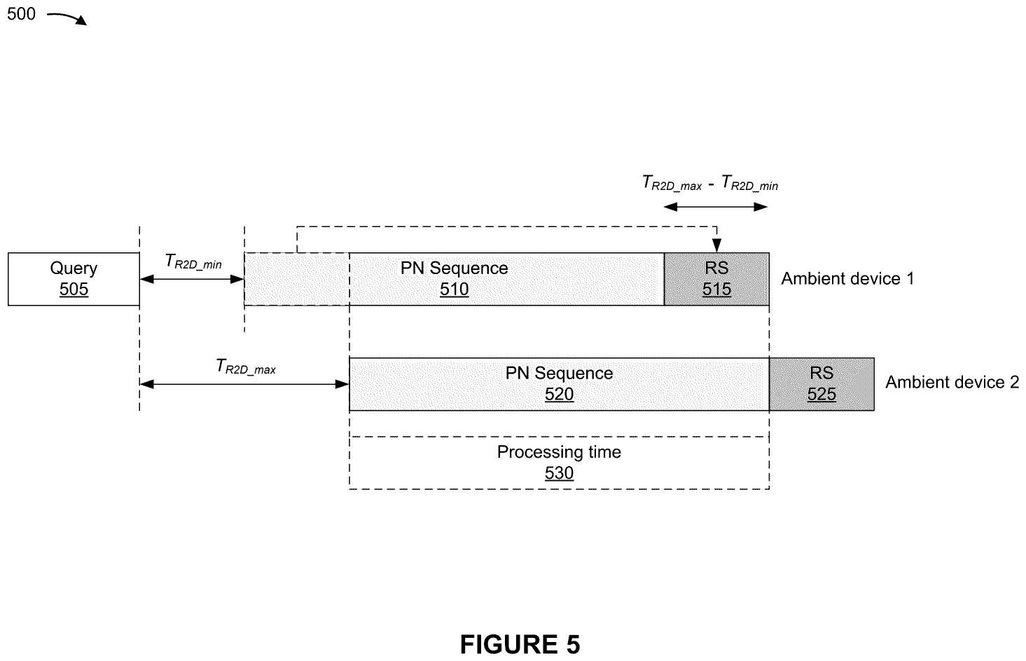

In some aspects, the reader device 410 may receive multiple random access messages (for example, from multiple different ambient devices). A first random access message may include a first pseudorandom noise sequence followed by a first redundancy sequence, and a second random access message may include a second pseudorandom noise sequence and a second redundancy sequence. The first random access message may begin at a time that corresponds to the minimum permitted duration, or at a time that is after the minimum permitted duration but before a beginning of the second random access message. The second random access message may begin at a time that corresponds to the maximum permitted duration or a time that is before the maximum permitted duration but after a beginning of the first random access message. The reader device 410 may begin processing the first random access message and the second random access message at a time that corresponds to the maximum permitted duration. Additionally or alternatively, the reader device 410 may begin processing the first random access message and the second random access message at a time that corresponds to a beginning of the second pseudorandom noise sequence included in the second random access message. The reader device 410 may complete the processing of the first random access message and the second random access message at a time that corresponds to the end of the first redundancy sequence included in the first random access message and that corresponds to the end of the second pseudorandom noise sequence included in the second random access message. Therefore, the first random access message and the second random access message may be orthogonal to each other. Additional details regarding these features are described in connection with FIG. 5.

In some aspects, the ambient device 405 may select at least one of a TDM resource or an FDM resource (TDM/FDM resource) for transmitting the random access message (Message 1). The ambient device 405 may select the TDM/FDM resource in accordance with a processing delay of the ambient device 405 or in accordance with a sampling frequency offset used by the ambient device 405. In some aspects, the reader device 410 may indicate, for each TDM/FDM resource in the query message, a range of processing delays. An example of the processing delay ranges for each TDM/FDM resource is shown in Table 1, where T₁ indicates a first processing delay, T₂ indicates a second processing delay, T₃ indicates a third processing delay, and T₄ indicates a fourth processing delay (in increasing order of time).

TABLE 1
Processing Delay Range for Random Access Message Resources
Time →

| | | | |
|---|---|---|---|
| Frequency 1 | [T₂, T₃] | [T₃, T₄] | . . . |
| | . . . | . . . | . . . |
| | [T₁, T₂] | [T₃, T₄] | . . . |

In some aspects, a smaller time delay variation may be allowed within multiple FDM resources for a TDM resource, for example, to enable improved filtering operations at the reader device 410. The ambient device 405 may initially select a set of TDM/FDM resources in accordance with a processing delay or a sampling frequency offset of the ambient device 405. Subsequently, the ambient device 405 may select (for example, randomly) a pseudorandom noise sequence from one or more available CDM sequences associated with the set of TDM/FDM resources. The ambient device 405 may be configured with information that indicates the processing delay of the query message by the ambient device 405.

In some aspects, different device types may have different processing delays for processing the query message. An example of these device types and associated time and frequency resources are shown in Table 2.

TABLE 2
Processing Delay Range for Random Access Message Resources
Time →

| | | | |
|---|---|---|---|
| Frequency 1 | Device Type 1 | Device Type 2A | Device Type 2B |
| | . . . | . . . | . . . |
| | Device Type 1 | Device Type 2A | Device Type 2B |

The ambient device 405 may select the TDM resources, the FDM resources, and/or the CDM resources (TDM/FDM/CDM resources) in accordance with the device type information. For example, the ambient device 405 may select the TDM/FDM/CDM resources associated with Device Type 2A in accordance with the ambient device 405 being a Device Type 2A (and/or in accordance with the ambient device 405 having one or more characteristics of the Device Type 2A). Since the processing delay range may be limited for each resource, the duration of the redundancy sequence can be shorter, thereby reducing power consumption by the ambient device 405. Additionally or alternatively, a redundancy sequence having a shorter duration may enable improved resource utilization, for example, since the reader device 410 may assign a guard time for each time resource in accordance with a maximum processing delay.

In some aspects, the reader device 410 may allocate the same processing delay requirement(s) to different FDM resources within the same time resource. In such examples, different FDM resources may be configured with the same guard time, which may enable improved filtering operations at the reader device 410. An example of the same processing delay requirements being allocated to different FDM resources within the same time resource is shown in Table 3.

TABLE 3
Processing Delay Range for Random Access Message Resources
Time →

| | | | |
|---|---|---|---|
| Frequency 1 | [T₁, T₂] | [T₂, T₃] | . . . |
| | . . . | . . . | . . . |
| | [T₁, T₂] | [T₂ , T₃] | . . . |

In some aspects, the quantity of resources allocated for a given ambient device processing time may be in accordance with an implementation of the reader device 410. The reader device 410 may obtain the ambient device processing time, for example, during a read operation between the reader device 410 and the ambient device 405.

In a third operation 425, the reader device 410 may transmit, and the ambient device 405 may receive, a resource allocation. The resource allocation may be an allocation of resources for Message 3 transmissions. In some aspects, the resource allocation may be in accordance with the processing delay requirements of the ambient device 405. Therefore, the reader device 410 may allocate the resources (for example, the guard time) for the Message 3 transmissions in accordance with the Message 1 communications described herein. This may improve a resource utilization for the Message 3 transmissions.

FIG. 5 is a diagram illustrating an example 500 of random access messages with pseudorandom noise sequences and redundancy sequences in accordance with the present disclosure. As described herein, a reader device may transmit a query message to an ambient device. For example, the reader device 410 may transmit a query 505 to one or more ambient devices 405. A first ambient device (shown as ambient device 1) may transmit, to the reader device 410 and responsive to receiving the query 505, a first random access message that includes a PN sequence 510 and an RS 515. A second ambient device (shown as ambient device 2) may transmit, to the reader device 410 and responsive to receiving the query 505, a second random access message that includes a PN sequence 520 and an RS 525. The PN sequence 510 may begin at a time that corresponds to the minimum permitted duration (T_{R2D_min}), or at a time that is after (T_{R2D_min}) but before a beginning of the PN sequence 520. The second random access message may begin at a time that corresponds to the maximum permitted duration (T_{R2D_max}) or a time that is before (T_{R2D_max}) but after a beginning of the PN sequence 510. The RS 515 may be a repetition of an initial portion of the PN sequence 510. Both the RS 515 and the initial portion of the PN sequence 510 may have a duration that is equal to the maximum permitted duration (T_{R2D_max}) subtracted by the minimum permitted duration (T_{R2D_min}). Therefore, a processing time 530 by the reader device 410 may be reduced to a duration that is between a first time associated with a beginning of the PN sequence 520 and a second time associated with an end of the RS 515 and an end of the PN sequence 520.

FIG. 6 is a flowchart illustrating an example process 600 performed, for example, at an ambient device or an apparatus of an ambient device that supports wireless communications in accordance with the present disclosure. Example process 600 is an example where the apparatus or the ambient device (for example, ambient device 405) performs operations associated with ambient device random access message transmissions.

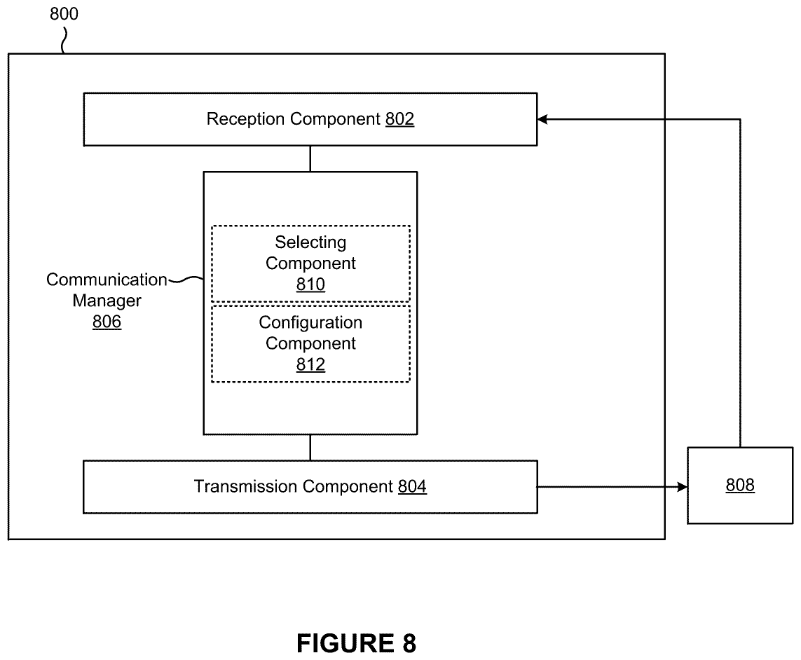

As shown in FIG. 6, in some aspects, process 600 may include receiving, from a reader device, a query message (block 610). For example, the ambient device (such as by using communication manager 806 or reception component 802, depicted in FIG. 8) may receive, from a reader device, a query message, as described above.

As further shown in FIG. 6, in some aspects, process 600 may include transmitting, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message (block 620). For example, the ambient device (such as by using communication manager 806 or transmission component 804, depicted in FIG. 8) may transmit, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message, as described above.

Process 600 may include additional aspects, such as any single aspect or any combination of aspects described below or in connection with one or more other processes described elsewhere herein.

In a first additional aspect, the duration of the redundancy sequence is equal to the maximum permitted duration subtracted by the minimum permitted duration.

In a second additional aspect, alone or in combination with the first aspect, process 600 includes receiving, from the reader device, configuration information that includes an indication of the minimum permitted duration and the maximum permitted duration.

In a third additional aspect, alone or in combination with one or more of the first and second aspects, the minimum permitted duration and the maximum permitted duration are in accordance with at least one of a processing delay of the ambient device, a round-trip time for communications between the ambient device and the reader device, or a sampling frequency offset.

In a fourth additional aspect, alone or in combination with one or more of the first through third aspects, the redundancy sequence includes a repetition of a portion of the pseudorandom noise sequence.

In a fifth additional aspect, alone or in combination with one or more of the first through fourth aspects, the redundancy sequence is included after the pseudorandom noise sequence in the random access message.

In a sixth additional aspect, alone or in combination with one or more of the first through fifth aspects, the portion of the pseudorandom noise sequence is an initial portion of the pseudorandom noise sequence, the initial portion of the pseudorandom noise sequence having a duration that is equal to the maximum permitted duration subtracted by the minimum permitted duration.

In a seventh additional aspect, alone or in combination with one or more of the first through sixth aspects, an end of the redundancy sequence included in the random access message aligns with an end of another pseudorandom noise sequence included in another random access message transmitted by another ambient device.

In an eighth additional aspect, alone or in combination with one or more of the first through seventh aspects, the redundancy sequence is included before the pseudorandom noise sequence in the random access message.

In a ninth additional aspect, alone or in combination with one or more of the first through eighth aspects, the portion of the pseudorandom noise sequence is an end portion of the pseudorandom noise sequence, the end portion of the pseudorandom noise sequence having a duration that is equal to the maximum permitted duration subtracted by the minimum permitted duration.

In a tenth additional aspect, alone or in combination with one or more of the first through ninth aspects, a beginning of another redundancy sequence included in another random access message transmitted by another ambient device aligns with a beginning of the pseudorandom noise sequence included in the random access message.

In an eleventh additional aspect, alone or in combination with one or more of the first through tenth aspects, the query message is a Message 0 of a random access process and the random access message is a Message 1 of the random access process.

In a twelfth additional aspect, alone or in combination with one or more of the first through eleventh aspects, process 600 includes selecting at least one of a TDM resource or a FDM resource for the random access message in accordance with a processing delay of the ambient device.

In a thirteenth additional aspect, alone or in combination with one or more of the first through twelfth aspects, process 600 includes receiving, for each TDM resource of a plurality of TDM resources included in the query message, or for each FDM resource of a plurality of FDM resources included in the query message, a range of candidate processing delays.

In a fourteenth additional aspect, alone or in combination with one or more of the first through thirteenth aspects, process 600 includes selecting a TDM resource of the plurality of TDM resources or an FDM resource of the plurality of FDM resources in accordance with a processing delay of the ambient device, wherein the processing delay of the ambient device is included in the range of candidate processing delays.

In a fifteenth additional aspect, alone or in combination with one or more of the first through fourteenth aspects, process 600 includes randomly selecting the pseudorandom noise sequence of the random access message in accordance with a CDM resource associated with at least one of the TDM resource or the FDM resource.

In a sixteenth additional aspect, alone or in combination with one or more of the first through fifteenth aspects, the range of candidate processing delays includes at least a first processing delay range associated with a first type of ambient device and a second processing delay range associated with a second type of ambient device.

In a seventeenth additional aspect, alone or in combination with one or more of the first through sixteenth aspects, process 600 includes selecting at least one of a TDM resource of the plurality of TDM resources or an FDM resource of the plurality of FDM resources in accordance with the ambient device being the first type of ambient device or the second type of ambient device.

In an eighteenth additional aspect, alone or in combination with one or more of the first through seventeenth aspects, a processing delay included in the range of candidate processing delays is associated with two or more FDM resources of the plurality of FDM resources, the two or more FDM resources being associated with a same TDM resource of the plurality of TDM resources.

In a nineteenth additional aspect, alone or in combination with one or more of the first through eighteenth aspects, the two or more FDM resources associated with the same TDM resource include a same guard time.

In a twentieth additional aspect, alone or in combination with one or more of the first through nineteenth aspects, process 600 includes transmitting, to the reader device, during a read operation by the reader device, an indication of a processing delay of the ambient device.

In a twenty-first additional aspect, alone or in combination with one or more of the first through twentieth aspects, process 600 includes receiving, from the reader device, a resource allocation for transmitting one or more other messages after the random access message.

In a twenty-second additional aspect, alone or in combination with one or more of the first through twenty-first aspects, the resource allocation includes an indication of a guard time for the one or more other messages.

In a twenty-third additional aspect, alone or in combination with one or more of the first through twenty-second aspects, the one or more other messages include a Message 3 of a random access process.

In a twenty-fourth additional aspect, alone or in combination with one or more of the first through twenty-third aspects, a first processing delay of a plurality of processing delays for the ambient device is associated with a first SFO of the random access message and a second processing delay of the plurality of processing delays for the ambient device is associated with a second SFO of the random access message.

In a twenty-fifth additional aspect, alone or in combination with one or more of the first through twenty-fourth aspects, the query message is associated with an inventory process of the reader device.

In a twenty-sixth additional aspect, alone or in combination with one or more of the first through twenty-fifth aspects, the reader device is a network node.

In a twenty-seventh additional aspect, alone or in combination with one or more of the first through twenty-sixth aspects, the reader device is a UE that is configured to communicate with the ambient device and a network node.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a reader device or an apparatus of a reader device that supports wireless communications in accordance with the present disclosure. Example process 700 is an example where the apparatus or the reader device (for example, reader device 410 performs operations associated with ambient device random access message transmissions.

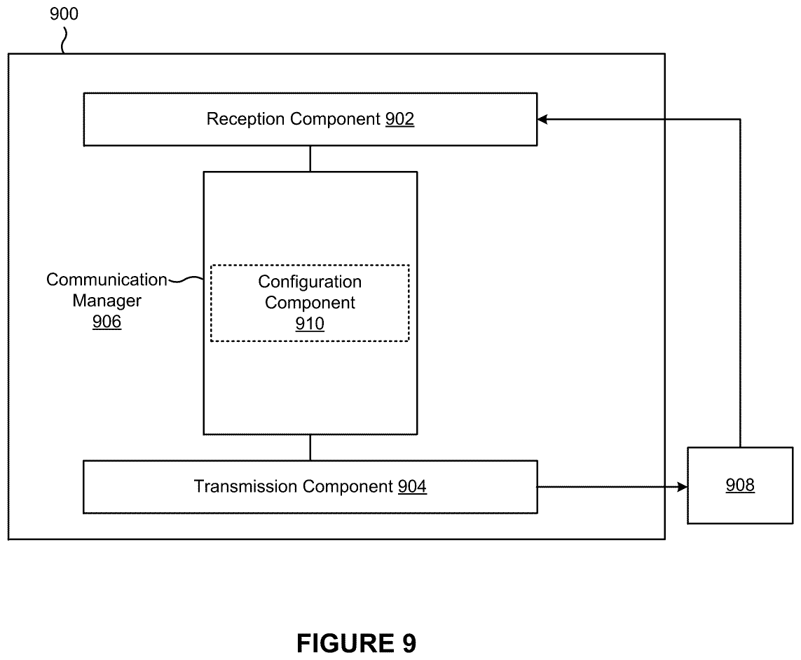

As shown in FIG. 7, in some aspects, process 700 may include transmitting, to an ambient device, a query message (block 710). For example, the reader device (such as by using communication manager 906 or transmission component 904, depicted in FIG. 9) may transmit, to an ambient device, a query message, as described above.

As further shown in FIG. 7, in some aspects, process 700 may include receiving, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message (block 720). For example, the reader device (such as by using communication manager 906 or reception component 902, depicted in FIG. 9) may receive, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message, as described above.

Process 700 may include additional aspects, such as any single aspect or any combination of aspects described below or in connection with one or more other processes described elsewhere herein.

In a first additional aspect, the duration of the redundancy sequence is equal to the maximum permitted duration subtracted by the minimum permitted duration.

In a second additional aspect, alone or in combination with the first aspect, process 700 includes transmitting, to the ambient device, configuration information that includes an indication of the minimum permitted duration and the maximum permitted duration.

In a third additional aspect, alone or in combination with one or more of the first and second aspects, the minimum permitted duration and the maximum permitted duration are in accordance with at least one of a processing delay of the ambient device, a round-trip time for communications between the ambient device and the reader device, or a sampling frequency offset.

In a fourth additional aspect, alone or in combination with one or more of the first through third aspects, the redundancy sequence includes a repetition of a portion of the pseudorandom noise sequence.

In a fifth additional aspect, alone or in combination with one or more of the first through fourth aspects, the redundancy sequence is included after the pseudorandom noise sequence in the random access message.

In a sixth additional aspect, alone or in combination with one or more of the first through fifth aspects, the portion of the pseudorandom noise sequence is an initial portion of the pseudorandom noise sequence, the initial portion of the pseudorandom noise sequence having a duration that is equal to the maximum permitted duration subtracted by the minimum permitted duration.

In a seventh additional aspect, alone or in combination with one or more of the first through sixth aspects, process 700 includes receiving another random access message that includes another pseudorandom noise sequence, wherein at least a portion of the redundancy sequence included in the random access message overlaps with an end of the other pseudorandom noise sequence included in the other random access message.

In an eighth additional aspect, alone or in combination with one or more of the first through seventh aspects, the redundancy sequence is included before the pseudorandom noise sequence in the random access message.

In a ninth additional aspect, alone or in combination with one or more of the first through eighth aspects, the portion of the pseudorandom noise sequence is an end portion of the pseudorandom noise sequence, the end portion of the pseudorandom noise sequence having a duration that is equal to the maximum permitted duration subtracted by the minimum permitted duration.

In a tenth additional aspect, alone or in combination with one or more of the first through ninth aspects, process 700 includes transmitting another random access message that includes another pseudorandom noise sequence, wherein a beginning of the redundancy sequence included in the other random access message overlaps with at least a portion of the pseudorandom noise sequence included in the random access message.

In an eleventh additional aspect, alone or in combination with one or more of the first through tenth aspects, the query message is a Message 0 of a random access process and the random access message is a Message 1 of the random access process.

In a twelfth additional aspect, alone or in combination with one or more of the first through eleventh aspects, at least one of a TDM resource or a FDM resource for the random access message is in accordance with a processing delay of the ambient device.

In a thirteenth additional aspect, alone or in combination with one or more of the first through twelfth aspects, process 700 includes transmitting, for each TDM resource of a plurality of TDM resources included in the query message, or for each FDM resource of a plurality of FDM resources included in the query message, a range of candidate processing delays.

In a fourteenth additional aspect, alone or in combination with one or more of the first through thirteenth aspects, a TDM resource of the plurality of TDM resources or an FDM resource of the plurality of FDM resources is in accordance with a processing delay of the ambient device, wherein the processing delay of the ambient device is included in the range of candidate processing delays.

In a fifteenth additional aspect, alone or in combination with one or more of the first through fourteenth aspects, the range of candidate processing delays includes at least a first processing delay range associated with a first type of ambient device and a second processing delay range associated with a second type of ambient device.

In a sixteenth additional aspect, alone or in combination with one or more of the first through fifteenth aspects, a processing delay included in the range of candidate processing delays is associated with two or more FDM resources of the plurality of FDM resources, the two or more FDM resources being associated with a same TDM resource of the plurality of TDM resources.

In a seventeenth additional aspect, alone or in combination with one or more of the first through sixteenth aspects, the two or more FDM resources associated with the same TDM resource include a same guard time.

In an eighteenth additional aspect, alone or in combination with one or more of the first through seventeenth aspects, process 700 includes receiving, from the ambient device, during a read operation by the reader device, an indication of a processing delay of the ambient device.

In a nineteenth additional aspect, alone or in combination with one or more of the first through eighteenth aspects, process 700 includes transmitting, to the reader device, a resource allocation for transmitting one or more other messages after the random access message.

In a twentieth additional aspect, alone or in combination with one or more of the first through nineteenth aspects, the resource allocation includes an indication of a guard time for the one or more other messages.

In a twenty-first additional aspect, alone or in combination with one or more of the first through twentieth aspects, the one or more other messages include a Message 3 of a random access process.

In a twenty-second additional aspect, alone or in combination with one or more of the first through twenty-first aspects, a first processing delay of a plurality of processing delays for the ambient device is associated with a first SFO of the random access message and a second processing delay of the plurality of processing delays for the ambient device is associated with a second SFO of the random access message.

In a twenty-third additional aspect, alone or in combination with one or more of the first through twenty-second aspects, the query message is associated with an inventory process of the reader device.

In a twenty-fourth additional aspect, alone or in combination with one or more of the first through twenty-third aspects, the reader device is a network node.

In a twenty-fifth additional aspect, alone or in combination with one or more of the first through twenty-fourth aspects, the reader device is a UE that is configured to communicate with the ambient device and a network node.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports wireless communications in accordance with the present disclosure. The apparatus 800 may be an ambient device, or an ambient device may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 140). In some aspects, the communication manager 806 is the communication manager 150.

In some aspects, the apparatus 800 may be configured to and/or operable to perform one or more operations described herein in connection with FIGS. 4-5. Additionally or alternatively, the apparatus 800 may be configured to and/or operable to perform one or more processes described herein, such as process 600 of FIG. 6.

The reception component 802 may receive communications, such as reference signals, control information, and/or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the ambient device described above in connection with FIG. 1, such as a radio, one or more RF chains, one or more transceivers, or one or more modems, each of which may in turn be coupled with one or more antennas of the ambient device.

The transmission component 804 may transmit communications, such as reference signals, control information, and/or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the ambient device described above in connection with FIG. 1, such as a radio, one or more RF chains, one or more transceivers, or one or more modems, each of which may in turn be coupled with one or more antennas of the ambient device. In some aspects, the transmission component 804 may be co-located with the reception component 802.

The communication manager 806 may receive or may cause the reception component 802 to receive, from a reader device, a query message. The communication manager 806 may transmit or may cause the transmission component 804 to transmit, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message. In some aspects, the communication manager 806 may perform one or more operations described elsewhere herein as being performed by one or more components of the communication manager 806.

In some aspects, the communication manager 806 includes a set of components, such as a selecting component 810 and/or a configuration component 812. Alternatively, the set of components may be separate and distinct from the communication manager 806. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 802 may receive, from a reader device, a query message. The transmission component 804 may transmit, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message.

The reception component 802 and/or the configuration component 812 may receive, from the reader device, configuration information that includes an indication of the minimum permitted duration and the maximum permitted duration. The selecting component 810 may select at least one of a TDM resource or a FDM resource for the random access message in accordance with a processing delay of the ambient device. The reception component 802 may receive, for each TDM resource of a plurality of TDM resources included in the query message, or for each FDM resource of a plurality of FDM resources included in the query message, a range of candidate processing delays. The selecting component 810 may select a TDM resource of the plurality of TDM resources or an FDM resource of the plurality of FDM resources in accordance with a processing delay of the ambient device, wherein the processing delay of the ambient device is included in the range of candidate processing delays. The selecting component 810 may randomly select the pseudorandom noise sequence of the random access message in accordance with a CDM resource associated with at least one of the TDM resource or the FDM resource. The selecting component 810 may select at least one of a TDM resource of the plurality of TDM resources or an FDM resource of the plurality of FDM resources in accordance with the ambient device being the first type of ambient device or the second type of ambient device. The transmission component 804 may transmit, to the reader device, during a read operation by the reader device, an indication of a processing delay of the ambient device. The reception component 802 may receive, from the reader device, a resource allocation for transmitting one or more other messages after the random access message.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports wireless communications in accordance with the present disclosure. The apparatus 900 may be a reader device, or a reader device may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 145). In some aspects, the communication manager 906 is the communication manager 155.

In some aspects, the apparatus 900 may be configured to and/or operable to perform one or more operations described herein in connection with FIGS. 4-5. Additionally or alternatively, the apparatus 900 may be configured to and/or operable to perform one or more processes described herein, such as process 700 of FIG. 7.

The reception component 902 may receive communications, such as reference signals, control information, and/or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the reader device described above in connection with FIG. 1, such as a radio, one or more RF chains, one or more transceivers, or one or more modems, each of which may in turn be coupled with one or more antennas of the reader device.

The transmission component 904 may transmit communications, such as reference signals, control information, and/or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the reader device described above in connection with FIG. 1, such as a radio, one or more RF chains, one or more transceivers, or one or more modems, each of which may in turn be coupled with one or more antennas of the reader device. In some aspects, the transmission component 904 may be co-located with the reception component 902.

The communication manager 906 may receive or may cause the reception component 902 to receive, from a reader device, a query message. The communication manager 906 may transmit or may cause the transmission component 904 to transmit, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message. In some aspects, the communication manager 906 may perform one or more operations described elsewhere herein as being performed by one or more components of the communication manager 906.

In some aspects, the communication manager 906 includes a set of components, such as a configuration component 910. Alternatively, the set of components may be separate and distinct from the communication manager 906. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 904 may transmit, to an ambient device, a query message. The reception component 902 may receive, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message.

The transmission component 904 and/or the configuration component 910 may transmit, to the ambient device, configuration information that includes an indication of the minimum permitted duration and the maximum permitted duration. The reception component 902 may receive another random access message that includes another pseudorandom noise sequence, wherein at least a portion of the redundancy sequence included in the random access message overlaps with an end of the other pseudorandom noise sequence included in the other random access message. The transmission component 904 may transmit another random access message that includes another pseudorandom noise sequence, wherein a beginning of the redundancy sequence included in the other random access message overlaps with at least a portion of the pseudorandom noise sequence included in the random access message. The transmission component 904 may transmit, for each TDM resource of a plurality of TDM resources included in the query message, or for each FDM resource of a plurality of FDM resources included in the query message, a range of candidate processing delays. The reception component 902 may receive, from the ambient device, during a read operation by the reader device, an indication of a processing delay of the ambient device. The transmission component 904 may transmit, to the reader device, a resource allocation for transmitting one or more other messages after the random access message.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method for wireless communication by an ambient device, comprising: receiving, from a reader device, a query message; and transmitting, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message.

Aspect 2: The method of Aspect 1, wherein the duration of the redundancy sequence is equal to the maximum permitted duration subtracted by the minimum permitted duration.

Aspect 3: The method of any of Aspects 1-2, further comprising receiving, from the reader device, configuration information that includes an indication of the minimum permitted duration and the maximum permitted duration.

Aspect 4: The method of any of Aspects 1-3, wherein the minimum permitted duration and the maximum permitted duration are in accordance with at least one of a processing delay of the ambient device or a sampling frequency offset.

Aspect 5: The method of any of Aspects 1-4, wherein the redundancy sequence includes a repetition of a portion of the pseudorandom noise sequence.

Aspect 6: The method of Aspect 5, wherein the redundancy sequence is included after the pseudorandom noise sequence in the random access message.

Aspect 7: The method of Aspect 6, wherein the portion of the pseudorandom noise sequence is an initial portion of the pseudorandom noise sequence, the initial portion of the pseudorandom noise sequence having a duration that is equal to the maximum permitted duration subtracted by the minimum permitted duration.

Aspect 8: The method of Aspect 7, wherein an end of the redundancy sequence included in the random access message aligns with an end of another pseudorandom noise sequence included in another random access message transmitted by another ambient device.

Aspect 9: The method of Aspect 5, wherein the redundancy sequence is included before the pseudorandom noise sequence in the random access message.

Aspect 10: The method of Aspect 9, wherein the portion of the pseudorandom noise sequence is an end portion of the pseudorandom noise sequence, the end portion of the pseudorandom noise sequence having a duration that is equal to the maximum permitted duration subtracted by the minimum permitted duration.

Aspect 11: The method of Aspect 10, wherein a beginning of another redundancy sequence included in another random access message transmitted by another ambient device aligns with a beginning of the pseudorandom noise sequence included in the random access message.

Aspect 12: The method of any of Aspects 1-11, wherein the query message is a Message 0 of a random access process and the random access message is a Message 1 of the random access process.

Aspect 13: The method of any of Aspects 1-12, further comprising selecting at least one of a time-division multiplexing (TDM) resource or a frequency-division multiplexing (FDM) resource for the random access message in accordance with a processing delay of the ambient device.

Aspect 14: The method of any of Aspects 1-13, further comprising receiving, for each time-division multiplexing (TDM) resource of a plurality of TDM resources included in the query message, or for each frequency-division multiplexing (FDM) resource of a plurality of FDM resources included in the query message, a range of candidate processing delays.

Aspect 15: The method of Aspect 14, further comprising selecting a TDM resource of the plurality of TDM resources or an FDM resource of the plurality of FDM resources in accordance with a processing delay of the ambient device, wherein the processing delay of the ambient device is included in the range of candidate processing delays.

Aspect 16: The method of Aspect 15, further comprising randomly selecting the pseudorandom noise sequence of the random access message in accordance with a code-division multiplexing (CDM) resource associated with at least one of the TDM resource or the FDM resource.

Aspect 17: The method of Aspect 14, wherein the range of candidate processing delays includes at least a first processing delay range associated with a first type of ambient device and a second processing delay range associated with a second type of ambient device.

Aspect 18: The method of Aspect 17, further comprising selecting at least one of a TDM resource of the plurality of TDM resources or an FDM resource of the plurality of FDM resources in accordance with the ambient device being the first type of ambient device or the second type of ambient device.

Aspect 19: The method of Aspect 14, wherein a processing delay included in the range of candidate processing delays is associated with two or more FDM resources of the plurality of FDM resources, the two or more FDM resources being associated with a same TDM resource of the plurality of TDM resources.

Aspect 20: The method of Aspect 19, wherein the two or more FDM resources associated with the same TDM resource include a same guard time.

Aspect 21: The method of Aspect 19, further comprising transmitting, to the reader device, during a read operation by the reader device, an indication of a processing delay of the ambient device.

Aspect 22: The method of Aspect 19, further comprising receiving, from the reader device, a resource allocation for transmitting one or more other messages after the random access message.

Aspect 23: The method of Aspect 22, wherein the resource allocation includes an indication of a guard time for the one or more other messages.

Aspect 24: The method of Aspect 22, wherein the one or more other messages include a Message 3 of a random access process.

Aspect 25: The method of any of Aspects 1-24, wherein a first processing delay of a plurality of processing delays for the ambient device is associated with a first sampling frequency offset (SFO) of the random access message and a second processing delay of the plurality of processing delays for the ambient device is associated with a second SFO of the random access message.

Aspect 26: The method of any of Aspects 1-25, wherein the query message is associated with an inventory process of the reader device.

Aspect 27: The method of any of Aspects 1-26, wherein the reader device is a network node.

Aspect 28: The method of any of Aspects 1-27, wherein the reader device is a user equipment that is configured to communicate with the ambient device and a network node.

Aspect 29: A method for wireless communication by a reader device, comprising: transmitting, to an ambient device, a query message; and receiving, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message.

Aspect 30: The method of Aspect 29, wherein the duration of the redundancy sequence is equal to the maximum permitted duration subtracted by the minimum permitted duration.

Aspect 31: The method of any of Aspects 29-30, further comprising transmitting, to the ambient device, configuration information that includes an indication of the minimum permitted duration and the maximum permitted duration.

Aspect 32: The method of any of Aspects 29-31, wherein the minimum permitted duration and the maximum permitted duration are in accordance with at least one of a processing delay of the ambient device or a sampling frequency offset.

Aspect 33: The method of any of Aspects 29-32, wherein the redundancy sequence includes a repetition of a portion of the pseudorandom noise sequence.

Aspect 34: The method of Aspect 33, wherein the redundancy sequence is included after the pseudorandom noise sequence in the random access message.

Aspect 35: The method of Aspect 34, wherein the portion of the pseudorandom noise sequence is an initial portion of the pseudorandom noise sequence, the initial portion of the pseudorandom noise sequence having a duration that is equal to the maximum permitted duration subtracted by the minimum permitted duration.

Aspect 36: The method of Aspect 35, further comprising receiving another random access message that includes another pseudorandom noise sequence, wherein at least a portion of the redundancy sequence included in the random access message overlaps with an end of the other pseudorandom noise sequence included in the other random access message.

Aspect 37: The method of Aspect 33, wherein the redundancy sequence is included before the pseudorandom noise sequence in the random access message.

Aspect 38: The method of Aspect 37, wherein the portion of the pseudorandom noise sequence is an end portion of the pseudorandom noise sequence, the end portion of the pseudorandom noise sequence having a duration that is equal to the maximum permitted duration subtracted by the minimum permitted duration.

Aspect 39: The method of Aspect 38, further comprising transmitting another random access message that includes another pseudorandom noise sequence, wherein a beginning of the redundancy sequence included in the other random access message overlaps with at least a portion of the pseudorandom noise sequence included in the random access message.

Aspect 40: The method of any of Aspects 29-39, wherein the query message is a Message 0 of a random access process and the random access message is a Message 1 of the random access process.

Aspect 41: The method of any of Aspects 29-40, wherein at least one of a time-division multiplexing (TDM) resource or a frequency-division multiplexing (FDM) resource for the random access message is in accordance with a processing delay of the ambient device.

Aspect 42: The method of any of Aspects 29-41, further comprising transmitting, for each time-division multiplexing (TDM) resource of a plurality of TDM resources included in the query message, or for each frequency-division multiplexing (FDM) resource of a plurality of FDM resources included in the query message, a range of candidate processing delays.

Aspect 43: The method of Aspect 42, wherein a TDM resource of the plurality of TDM resources or an FDM resource of the plurality of FDM resources is in accordance with a processing delay of the ambient device, wherein the processing delay of the ambient device is included in the range of candidate processing delays.

Aspect 44: The method of Aspect 42, wherein the range of candidate processing delays includes at least a first processing delay range associated with a first type of ambient device and a second processing delay range associated with a second type of ambient device.

Aspect 45: The method of Aspect 42, wherein a processing delay included in the range of candidate processing delays is associated with two or more FDM resources of the plurality of FDM resources, the two or more FDM resources being associated with a same TDM resource of the plurality of TDM resources.

Aspect 46: The method of Aspect 45, wherein the two or more FDM resources associated with the same TDM resource include a same guard time.

Aspect 47: The method of Aspect 45, further comprising receiving, from the ambient device, during a read operation by the reader device, an indication of a processing delay of the ambient device.

Aspect 48: The method of Aspect 45, further comprising transmitting, to the reader device, a resource allocation for transmitting one or more other messages after the random access message.

Aspect 49: The method of Aspect 48, wherein the resource allocation includes an indication of a guard time for the one or more other messages.

Aspect 50: The method of Aspect 48, wherein the one or more other messages include a Message 3 of a random access process.

Aspect 51: The method of any of Aspects 29-50, wherein a first processing delay of a plurality of processing delays for the ambient device is associated with a first sampling frequency offset (SFO) of the random access message and a second processing delay of the plurality of processing delays for the ambient device is associated with a second SFO of the random access message.

Aspect 52: The method of any of Aspects 29-51, wherein the query message is associated with an inventory process of the reader device.

Aspect 53: The method of any of Aspects 29-52, wherein the reader device is a network node.

Aspect 54: The method of any of Aspects 29-53, wherein the reader device is a user equipment that is configured to communicate with the ambient device and a network node.

Aspect 55: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-54.

Aspect 56: An apparatus for wireless communication at a device, the apparatus comprising one or more memories and one or more processors coupled to the one or more memories, the one or more processors configured to cause the device to perform the method of one or more of Aspects 1-54.

Aspect 57: An apparatus for wireless communication, the apparatus comprising at least one means for performing the method of one or more of Aspects 1-54.

Aspect 58: A non-transitory computer-readable medium storing code for wireless communication, the code comprising instructions executable by one or more processors to perform the method of one or more of Aspects 1-54.

Aspect 59: A non-transitory computer-readable medium storing a set of instructions for wireless communication, the set of instructions comprising one or more instructions that, when executed by one or more processors of a device, cause the device to perform the method of one or more of Aspects 1-54.

Aspect 60: A device for wireless communication, the device comprising a processing system that includes one or more processors and one or more memories coupled with the one or more processors, the processing system configured to cause the device to perform the method of one or more of Aspects 1-54.

Aspect 61: An apparatus for wireless communication at a device, the apparatus comprising one or more memories and one or more processors coupled to the one or more memories, the one or more processors individually or collectively configured to cause the device to perform the method of one or more of Aspects 1-54.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An ambient device for wireless communication, comprising:
a processing system that includes one or more processors and one or more memories coupled with the one or more processors, the processing system configured to cause the ambient device to:
receive, from a reader device, a query message; and
transmit, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message.

2. The ambient device of claim 1, wherein the duration of the redundancy sequence is equal to the maximum permitted duration subtracted by the minimum permitted duration.

3. The ambient device of claim 1, wherein the processing system is further configured to cause the ambient device to receive, from the reader device, configuration information that includes an indication of the minimum permitted duration and the maximum permitted duration.

4. The ambient device of claim 1, wherein the minimum permitted duration and the maximum permitted duration are in accordance with at least one of a processing delay of the ambient device or a sampling frequency offset.

5. The ambient device of claim 1, wherein the redundancy sequence includes a repetition of a portion of the pseudorandom noise sequence.

6. The ambient device of claim 5, wherein the redundancy sequence is included after the pseudorandom noise sequence in the random access message.

7. The ambient device of claim 6, wherein the portion of the pseudorandom noise sequence is an initial portion of the pseudorandom noise sequence, the initial portion of the pseudorandom noise sequence having a duration that is equal to the maximum permitted duration subtracted by the minimum permitted duration.

8. The ambient device of claim 5, wherein the redundancy sequence is included before the pseudorandom noise sequence in the random access message.

9. The ambient device of claim 8, wherein the portion of the pseudorandom noise sequence is an end portion of the pseudorandom noise sequence, the end portion of the pseudorandom noise sequence having a duration that is equal to the maximum permitted duration subtracted by the minimum permitted duration.

10. The ambient device of claim 1, wherein the query message is a Message 0 of a random access process and the random access message is a Message 1 of the random access process.

11. The ambient device of claim 1, wherein the processing system is further configured to cause the ambient device to select at least one of a time-division multiplexing (TDM) resource or a frequency-division multiplexing (FDM) resource for the random access message in accordance with a processing delay of the ambient device.

12. The ambient device of claim 1, wherein the processing system is further configured to cause the ambient device to receive, for each time-division multiplexing (TDM) resource of a plurality of TDM resources included in the query message, or for each frequency-division multiplexing (FDM) resource of a plurality of FDM resources included in the query message, a range of candidate processing delays.

13. The ambient device of claim 12, wherein the processing system is further configured to cause the ambient device to select a TDM resource of the plurality of TDM resources or an FDM resource of the plurality of FDM resources in accordance with a processing delay of the ambient device, wherein the processing delay of the ambient device is included in the range of candidate processing delays.

14. The ambient device of claim 12, wherein the range of candidate processing delays includes at least a first processing delay range associated with a first type of ambient device and a second processing delay range associated with a second type of ambient device.

15. The ambient device of claim 12, wherein a processing delay included in the range of candidate processing delays is associated with two or more FDM resources of the plurality of FDM resources, the two or more FDM resources being associated with a same TDM resource of the plurality of TDM resources.

16. A reader device for wireless communication, comprising:
a processing system that includes one or more processors and one or more memories coupled with the one or more processors, the processing system configured to cause the reader device to:
transmit, to an ambient device, a query message; and
receive, from the ambient device, a random access message that includes a pseudorandom noise sequence and a redundancy sequence, wherein a duration of the redundancy sequence is in accordance with a minimum permitted duration between the ambient device receiving the query message and transmitting the random access message and a maximum permitted duration between the ambient device receiving the query message and transmitting the random access message.

17. The reader device of claim 16, wherein the duration of the redundancy sequence is equal to the maximum permitted duration subtracted by the minimum permitted duration.

18. The reader device of claim 16, wherein the minimum permitted duration and the maximum permitted duration are in accordance with at least one of a processing delay of the ambient device or a sampling frequency offset.

19. The reader device of claim 16, wherein the redundancy sequence includes a repetition of a portion of the pseudorandom noise sequence.

20. A method for wireless communication by an ambient device, comprising:
receiving, from a reader device, a query message; and
transmitting, to the reader device, a random access message that includes a pseudorandom noise sequence and a redundancy sequence, wherein a duration of the redundancy sequence is in accordance with a minimum permitted duration between receiving the query message and transmitting the random access message and a maximum permitted duration between receiving the query message and transmitting the random access message.
